(19) United States
(12) Patent Application Publication
(10) Pub. No.: US 2016/0063016 A1
(43) Pub. Date: Mar. 3, 2016

(54) SYSTEMS AND METHODS OF PUBLISHING CONTENT FROM ONE OR MORE SOURCES

(71) Applicant: Widespider, LLC, Baltimore, MD (US)

(72) Inventors: York Eggleston, Baltimore, MD (US); Llewellyn Wall, Arlington, VA (US)

(21) Appl. No.: 14/476,800

(22) Filed: Sep. 4, 2014

Related U.S. Application Data
(63) Continuation of application No. 14/475,153, filed on Sep. 2, 2014.

(51) Int. Cl. G06F 17/30

(52) U.S. Cl. CPC G06F 17/3089; G06F 17/30864

(57) ABSTRACT

A method and system for creating websites that provide customized published information from multiple sources based on user specified keywords and content sources. The user provides at least a keyword, selects at least one source of published content to search, places the source in a predetermined template, and generates computer instructions that causes a processor to search the selected source for published content related to the keyword, generates an organized listing of hyperlinks, generates a summary of text for each hyperlink, formats the hyperlinks and summaries, automatically updates the listing of hyperlinks and summaries, and provides the user with the computer instructions.

### BACKGROUND

Creating websites that provide information from multiple sources and that are directed to a particular topic are difficult to create and requires special programming skills. Moreover, once the website is created, the information on the webpage is typically static until the user updates the content, requiring a significant investment of time to gather and maintain current information.

Various embodiments of the present systems and methods recognize and address the foregoing considerations, and others, of prior art systems and methods.

### SUMMARY OF THE VARIOUS EMBODIMENTS

In various embodiments, a system for compiling and publishing desired content from various sources and in various formats comprises receiving, from a user (e.g. website designer, marketing manager, blogger, etc.) at least a keyword, a source of published content to search based on the received keyword, and a location within a predetermined template for the information to be placed. At least partially in response to receiving the information from the user, the system generates the computer instructions that will be embedded into the user's webpage, wherein the generated computer instructions are further configured to: (1) search at least one source for published content or associated media (such as posted videos) that is related to the received keyword; (2) generate a listing of hyperlinks for the published content organized chronologically; (3) generate a summary of text for each hyperlink, wherein the text is taken from the published content associated with the hyperlink; (4) format the listing of hyperlinks into one or more columns based on a template or per the specification of the format wizard and; (5) automatically update the listing of hyperlinks and the summary associated with each respective hyperlink according to a pre-determined time schedule.

In various embodiments, a computer-implemented method of publishing custom content comprises receiving from a user (e.g. user, marketing manager, blogger, etc.) at least one keyword. In response to receiving the at least one keyword from the user, the system builds a layout for the published content to be displayed and generates the computer instructions that are configured to be embedded into a webpage. The computer instructions are further configured to (1) search a network for published content that is related to the received at least one keyword and (2) generate a listing of hyperlinks for the published content, wherein the listing of hyperlinks are organized by at least one of: (a) a ranking of the published content as ranked by the source of the published content, (b) chronologically, and (c) the number of times the at least one keyword appears in the published content. The system is further configured to format the listing of hyperlinks for the published content into one or more columns based on the layout and automatically update the listing of hyperlinks according to a predetermined schedule. The system is further configured to provide the generated computer instructions to the user.

In various embodiments, a computer-implemented method of publishing custom content comprises presenting a user interface that is configured to at least: (1) receive one or more keywords from a user, (2) receive a selection of one or more sources of published content from a user, and (3) allow placement of the selected one or more sources of published content in a template that defines the layout of the published content. The system is further configured to receive: (1) at least one keyword from a user, (2) a user-selected first source to search for published content that is associated with the at least one received keyword, (3) a user-selected second source to search for published content that is associated with the at least one keyword, (4) placement by the user of the selected first source in the template, (5) placement by the user of the selected second source in a template or in a layout defined by either, and (6) generating computer instructions that are configured to be embedded into a webpage. The generated computer instructions are configured to: (1) search the selected first source for published content that is related to the received at least one keyword, (2) generate a first listing of hyperlinks for the published content from the first source, wherein the first listing of hyperlinks are organized chronologically, (3) search the selected second source for published content that is related to the received at least one keyword, (4) generate a second listing of hyperlinks for the published content from the second source, wherein the second listing of hyperlinks are organized chronologically, (5) generate a summary of text for each hyperlink in the first and second listings, wherein the text is taken from the published content associated with the respective hyperlink, (6) format the first listing of hyperlinks and the summary of text for each hyperlink based on the location of the selected first source in the template, (7) format the second listing of hyperlinks and the summary of text for each respective hyperlink based on the location of the second source in the template, and (8) automatically updating the first and second listings of hyperlinks according to a pre-determined schedule.

### BRIEF DESCRIPTION OF THE DRAWINGS

Various embodiments of systems and methods for the publication of user-selected information are described below. In the course of this description, reference will be made to the accompanying drawings, which are not necessarily drawn to scale and wherein:

FIG. 1 is a block diagram of an exemplary system for publishing webpages with customized content in accordance with an embodiment of the present system;

FIG. 2 is a block diagram of a publication server that may be used in the system shown in FIG. 1;

FIG. 3 depicts a flowchart that generally illustrates a method for publishing custom content that is based on one or more keywords;

FIG. 4A is an exemplary screen display for enabling a user to enter keywords and media sources for requested information;

FIG. 4B is an exemplary screen display to illustrate the webpage that is generated from a user-specified keyword and media source search

FIG. 5 is an exemplary screen display of an portal editor in accordance with an embodiment of the system;

FIG. 6 is an exemplary screen display of the portal editor of FIG. 5 having the fields filled out based on an preexisting custom published webpage;

FIG. 7 is an exemplary screen display of a custom published webpage that is based on the data entries in the portal editor of FIG. 6;

FIG. 8 is an exemplary screen display of a custom published newsletter that is based on the data entries in the portal editor of FIG. 6; and

FIG. 9 is an exemplary screen display of an e-mail campaign editor in accordance with an embodiment of the present system.

### DETAILED DESCRIPTION OF SOME EMBODIMENTS

Various embodiments will now be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview

A system and method of publishing custom content on a website is disclosed. The system allows a user to enter one or more keywords into a user interface that is used to search one or more sources for published content. Once the user enters the one or more keywords, the user may then select one or more sources of published content. For example, the user may select a Google® search, a Yahoo® search, a Bing® search, a website address, formatted text, a RSS feed, a YouTube® search and/or a Twitter® search as the source. When the user selects at least one source, the user may click on the source button and drag it into a template that is part of the user interface. The location in the template corresponds to the location of a listing of hyperlinks that is obtained from the source. Once the user drags the source button to the template, the system is configured to automatically populate the source button with the one or more keywords. Although the keywords are automatically populated into the source button located in the template, the system also allows the user to change the keyword associated with the selected source. Thus, when more than one source is selected, the first source may search on a first keyword and the second source may search on the same first keyword or on a second different keyword.

Once the user selects all of the sources of interest, the user may then select submit, which causes the system to generate computer code (e.g., computer instructions) that is configured to generate a website. The generated code may be used by the user's browser to render a website or the code may be provided so that it may be embedded in another website. In various embodiments, the computer instructions are configured to cause a processor to search the selected source(s) for published content that is related to the selected keyword(s). When information related to the received keyword is found, the system generates a listing of hyperlinks to the published content organized chronologically, a summary of text for each hyperlink, wherein the text is based on the published content associated with the hyperlink, and formats the listing of hyperlinks and the summary associated with each respective hyperlink into one or more columns based on the template. The system is further configured to update the listing of hyperlinks and the summary associated with each respective hyperlink according to a predetermined time schedule. In various embodiments, the updating of the listing of hyperlinks and the summary associated with each respective hyperlink, hereinafter referred to as “Culled Information” or “Culled Data”, may be updated continuously, or at set time increments depending on the needs of the user. Additionally, the embedded computer instructions may further enable the user to display how much time has elapsed since the last update of the Culled Information.

In various embodiments, the user interface may be shown using an internet browser. That is, the system may have a plug-in that integrates with a website browser. Thus, the user may activate the plug-in so that the user interface is displayed to the user. The user may then interact with the system using the user interface to input one or more keywords, sources and layouts. When the user presses the submit button, the system may provide computer instructions that cause the browser to directly render the webpage associated with the computer instructions, which then displays the Culled Data associated with the one or more keywords. Moreover, the system may also generate a hyperlink to the particular webpage, which may be saved in an area on the user-interface so that the user can manage their links (e.g., the user may re-render the webpage by clicking on a button associated with the hyperlink, add additional hyperlinks for other topics and sources, delete preexisting links, etc.). In various embodiments, the system may be configured to allow the user to name the link for easy recognition when the user has generated multiple links for various topics. Thus, the user interface may contain a listing of favorite hyperlinks to webpages that are based on differing keywords.

### Exemplary Technical Platforms

As will be appreciated by one skilled in the relevant field, the present systems and methods may be, for example, embodied as a computer system, a method, or a computer program product. Accordingly, various embodiments may be entirely hardware or a combination of hardware and software. Furthermore, particular embodiments may take the form of a computer program product stored on a computer-readable storage medium having computer-readable instructions (e.g., software) embodied in the storage medium. Various embodiments may also take the form of web-implemented computer software. Any suitable computer-readable storage medium may be utilized including, for example, hard disks, compact disks, DVDs, optical storage devices, and/or magnetic storage devices.

Various embodiments are described below with reference to block diagram and flowchart illustrations of methods, apparatuses, (e.g., systems), and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, a special purpose computer, or other programmable data processing apparatus that can direct a computer or other programmable data processing apparatus to function in a particular manner such that the instructions stored in the computer-readable memory produce an article of manufacture that is configured for implementing the functions specified in the flowchart block or blocks.

The computer instructions may execute entirely on the user's computer, partly on the user's computer, as a stand-alone software package, partly on a user's computer and partly on a remote computer, or entirely on the remote computer or server. In the latter scenario, the remote computer may be connected to the user's computer through any type of network, including but not limited to: a local area network (LAN); a wide area network (WAN); a cellular network; or the connection may be made to an external computer (for example, through the Internet using an Internet Service Provider).

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer-implemented process (e.g., method) such that the instructions that execute on the computer or other programmable apparatus provide steps for implementing the functions specified in the flowchart block or blocks.

### Example System Architecture

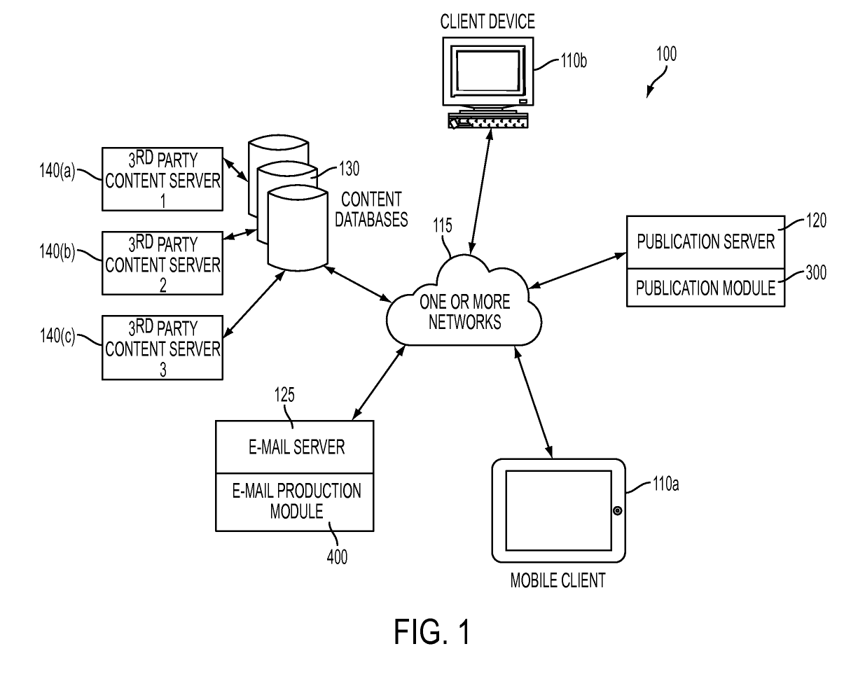

FIG. 1 is a block diagram of a publication system 100 according to a particular embodiment. As may be understood from this figure, the publication system 100 includes One or More Networks 115, One or More Computing Devices 110a, 110b (e.g., such as a smart phone, a tablet computer, a wearable computing device, a laptop computer, a desktop computer, etc.), Third-Party Content Servers 140a-140c operatively coupled to One or More Content Databases 140, and a Publication Sever 120 including a Publication module 300.

The One or More Networks 115 may include any of a variety of types of wired or wireless computer networks such as the Internet, a private intranet, a mesh network, a public switch telephone network (PSTN), or any other type of network (e.g., a network that uses Bluetooth or near field communications to facilitate communication between computing devices). The communication link between the One or More Computing Devices 110a, 110b and the Publication Server 120, Content Databases 130, and Content Servers 140a-140c may be, for example, implemented via a Local Area Network (LAN) or via the Internet.

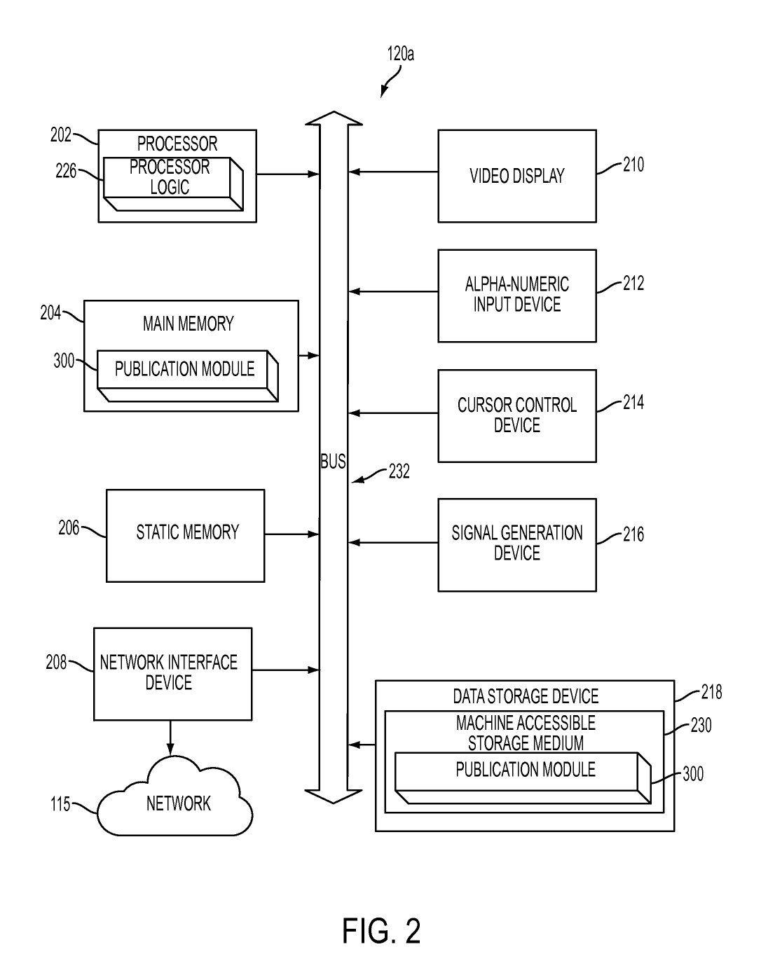

FIG. 2 illustrates a diagrammatic representation of the architecture for the Publication Server 120 that may be used within the Publication system 100. It should be understood that the computer architecture shown in FIG. 2 may also represent the computer architecture for any one of the One or More Computing Devices 110a, 110b, or the One or More Content Servers 140a, 140b, 140c shown in FIG. 1. In particular embodiments, the Publication Server 120 may be suitable for use as a computer within the context of the Publication system 100 that is configured for receiving a keyword from an user, allowing the user to select at least one source of published content to search based on the received keyword, allowing the user to place the at least one source in a predetermined template, and generating the computer instructions that are configured to be embedded into a webpage. The webpage may be locally hosted by the user, wherein the generated computer instructions cause the processor to search the selected at least one source for published content that is related to the received keyword, generate a list of hyperlinks to the published content that is organized chronologically, generate a summary of text for each hyperlink, the text taken from the published content associated with the hyperlink, format the Culled Information into one or more columns based on the template, and automatically updating the Culled Information according to a predetermined time schedule.

In particular embodiments, the Publication Server 120 may be connected (e.g., networked) to other computing devices in a LAN, an intranet, an extranet, and/or the Internet as shown in FIG. 1. As noted above, the Publication Server 120 may operate in the capacity of a server or a client computing device in a client-server network environment, or as a peer computing device in a peer-to-peer (or distributed) network environment. The Publication Server 120 may be a desktop personal computing device (PC), a tablet PC, a set-top box (STB), a Personal Digital Assistant (PDA), a cellular telephone, a web appliance, a network router, a switch or bridge, or any other computing device capable of executing a set of instructions (sequential or otherwise) that specify actions to be taken by that computing device. Further, while only a single computing device is illustrated, the term “computing device” shall also be interpreted to include any collection of computing devices that individually or jointly execute a set (or multiple sets) of instructions to perform any one or more of the methodologies discussed herein.

An exemplary Publication Server 120 includes a processing device 202, a main memory 204 (e.g., read-only memory (ROM), flash memory, dynamic random access memory (DRAM) such as synchronous DRAM (SDRAM) or Rambus DRAM (RDRAM), etc.), a static memory 206 (e.g., flash memory, static random access memory (SRAM), etc.), and a data storage device 218, which communicate with each other via a bus 232.

The processing device 202 represents one or more general-purpose or specific processing devices such as a microprocessor, a central processing unit (CPU), or the like. More particularly, the processing device 202 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. The processing device 202 may also be one or more special-purpose processing devices such as an application specific integrated circuit (ASIC), a field programmable gate array (FPGA), a digital signal processor (DSP), network processor, or the like. The processing device 202 may be configured to execute processing logic 226 for performing various operations and steps discussed herein.

The Publication Server 120 may further include a network interface device 208. The Publication Server 120 may also include a video display unit 210 (e.g., a liquid crystal display (LCD) or a cathode ray tube (CRT)), an alpha-numeric input device 212 (e.g., a keyboard), a cursor control device 214 (e.g., a mouse), and a signal generation device 216 (e.g., a speaker).

The data storage device 218 may include a non-transitory computing device-accessible storage medium 230 (also known as a non-transitory computing device-readable storage medium or a non-transitory computing device-readable medium) on which is stored one or more sets of instructions (e.g., the Publication module 300) embodying any one or more of the methodologies or functions described herein. The Publication module 300 may also reside, completely or at least partially, within the main memory 204 and/or within the processing device 202 during execution thereof by the Publication Server 120—the main memory 204 and the processing device 202 also constituting computing device-accessible storage media. The Publication Server Module 300 may further be transmitted or received over a network 115 via a network interface device 208.

While the computing device-accessible storage medium 230 is shown in an exemplary embodiment to be a single medium, the term “computing device-accessible storage medium” should be understood to include a single medium or multiple media (e.g., a centralized or distributed database, and/or associated caches and servers) that store the one or more sets of instructions. The term “computing device-accessible storage medium” should also be understood to include any medium that is capable of storing, encoding, or carrying a set of instructions for execution by the computing device and that causes the computing device to include any one or more of the methodologies of the present invention. The term “computing device-accessible storage medium” should accordingly be understood to include, but not be limited to, solid-state memories, optical and magnetic media, etc.

### Exemplary System Platform

Various embodiments of a system for the publication of information related to user-selected keywords across media sources are described below and may be implemented in any suitable context. For example, particular embodiments may be implemented within the context of a user-created webpage that is intended to provide information for a particular topic of interest. In still other embodiments, the system may also be integrated into other systems, for example, email newsletters, blog sites, etc.

Various aspects of the system's functionality may be executed by certain system modules, including the Publication Module 300. The Publication Module 300 is discussed in greater detail below.

Publication Server Module

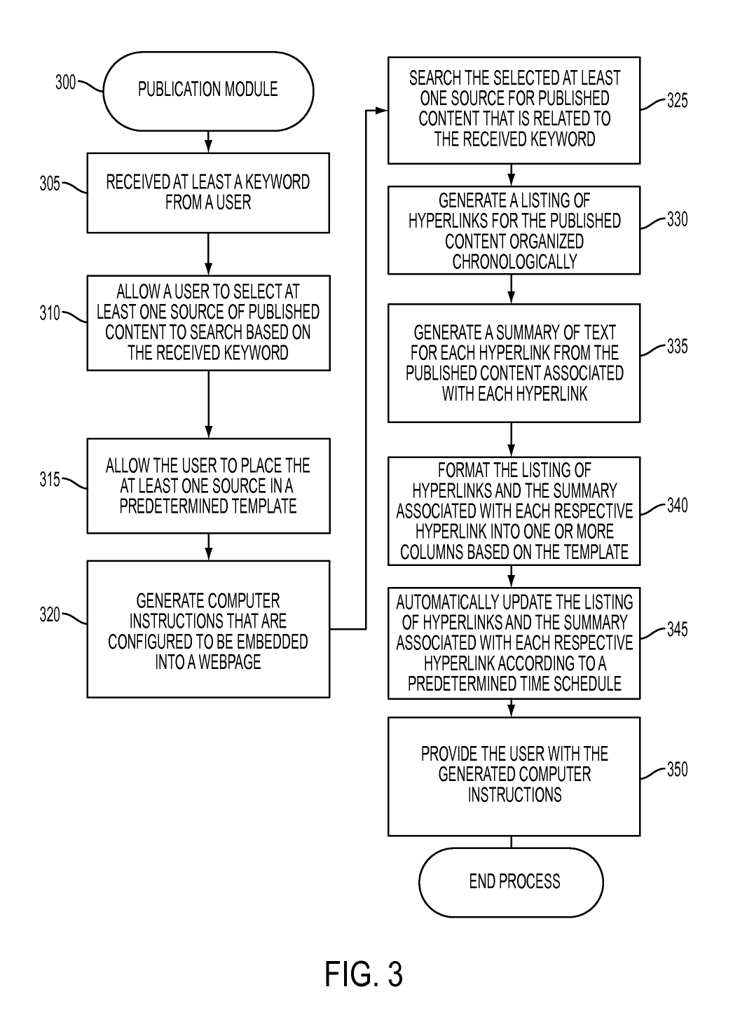

Referring to FIG. 3A, when executing the Publication Module 300, the system begins, in various embodiments, at Step 305 by receiving data from a user. In various embodiments, the system is configured to receive at least a keyword from a user regarding an area of interest or a topic in which the user is interested. In some embodiments, the system may be configured to present a user interface to the user that allows the user to enter the keyword. In various embodiments, this keyword may be a natural language search of a single word, a phrase, an idiom, a term of art, etc., or may be a Boolean search as per the needs of the user.

In particular embodiments, the keyword selected in Step 305 may be selected from a webpage. In this particular embodiment, a browser plugin is utilized to provide integrated right-click context menu functionality. In this particular embodiment, a user may highlight an unknown or known term from a webpage, right-click on that word to open the context menu, and select the plugin integrated context menu option to select the link causing the highlighted keyword to be selected as the keyword used in a search. In these embodiments, the system may then be configured to open the user interface and auto-populate the highlighted text as the keyword.

At Step 310, the system is configured to allow a user to select at least one source of published content to search at least partially based on the received keyword. In various embodiments, these sources of published content are selected from a group consisting of: (1) a Google search, (2) a Yahoo search, (3) a Bing search, (4) a website address, (5) an RSS feed, (6) a YouTube search, (7) an HTML widget, (8) formatted text and (9) a Twitter search. In various embodiments, the system is configured to allow the user to select any number of suitable sources or to allow the user to supply their own source by web address. Once the user selects at least one source, the keyword is automatically populated in the selected source designator. In various embodiments, although the keyword is auto-populated, the system will still allow the user to change the keyword assigned to the selected source.

Continuing at Step 315, the system is configured to allow the user to place the at least one source in a predetermined template. For example, in various embodiments, the system is configured to present the user with a webpage template. This template may be presented to the user, in various embodiments, as a CSS template, in which the user can drag and drop the source into at least one of several pre-defined columns. Additionally, in various embodiments, the differing media sources can be placed in the same column as each other or may be placed in one of several separate columns. In various embodiments as discussed above, when the source is selected and placed into the template, the source is auto-populated with the keyword. Thus, when more than one source is selected, each selected source may use the same keyword. In other embodiments, the user may change the keyword associated with one or more of the selected sources depending on the user's needs. That is, the first source may use the keyword entered at step 305 and a second selected source may use a second keyword that the user enters in place of the first keyword that was auto-populated into the second selected source.

Continuing at Step 320, the system is configured to generate computer instructions that are configured to generate a webpage. In particular embodiments, the system is configured to generate computer instructions based on one or more computer languages selected from HTML, JavaScript, CSS, and XML. In particular embodiments, the generation of the computer instructions may be performed locally by the user's computing device or may be generated on a remote-server. Additionally, the generated computer instructions, in various embodiments, are configured to be embedded into a webpage. That webpage may be an existing webpage or blog that utilizes varying style elements for different pages or functions, or may be a CSS template utilized by the user in order to retain style across pages. In other embodiments, the generated computer instructions may be used by the user's web browser to render a webpage of customized published content.

In various embodiments where a browser plugin is used, when the user submits the template and selected sources, the system may be configured to generate computer instructions based on the template, selected sources, and keyword that can be used locally by the user's browser. That is, instead of generating computer instructions that are configured to be embedded into a webpage, the generated computer instructions are used locally by the user's browser to generate a webpage containing customized content based on the keywords.

Continuing at Step 325, the system is further configured to search the one or more selected sources for published content that is related to the received keyword. In particular embodiments, the system is further configured to search the multiple selected sources in Step 310 for the received keyword of Step 305 in multiple manners. In particular embodiments, the keyword search across a traditional search engine (i.e. Google®, Yahoo®, Bing®, etc.) may include results to a variety of media types (i.e. news articles, blogs, Vimeo videos, etc.). In various embodiments, these results may be parsed from the respective search engine results such that only certain types of media results will be searched. Further search limiting parameters may be implemented by the user (i.e. to limit search results to those within a set data range, to limit results to a specific source type (i.e. non-blog sources for news, etc.), to limit search results to those published within a set time from the current date and time, or to sort search results by any variety of factors (rating based on relevance, rating based on views, chronologically, etc.).

Continuing at Step 330, the system is further configured to generate a listing of hyperlinks for the published content, which may be organized chronologically. In various embodiments, the system is configured to search across the selected sources in Step 325 for results relevant to the keyword selected by the user in Step 305. When the results of the search are returned, the system, in various embodiments, may be configured to generate a list of hyperlinks that is sorted first by relevance. In some embodiments, once the system determines particular results that meet a threshold relevancy, or meet another pre-determined characteristic (e.g. views, pages linking to, utilizing a proprietary ranking system, etc.), the results selected from the returned results are ordered chronologically.

Continuing at Step 335, the system is further configured to generate a summary of text for each hyperlink based on the published content associated with each hyperlink. In various embodiments, the system is configured to generate a summary of text for each hyperlink, utilizing the provided description, or some portion of the text from the linked source. In particular embodiments, the summary may be a designated number of characters taken directly from the source, a designated number of sentences taken directly from the source, or a designated number of characters or sentences generated by the system based on the source. In other embodiments, the summary of text may alternatively be generated from the meta-data of the source address. In yet other embodiments, the summary of text may be generated using a natural language program that takes the text from the content associated with the hyperlink and rewords the text.

Continuing at Step 340, the system is configured to format the listing of hyperlinks and the summary associated with each respective hyperlink, as generated in Step 330 and Step 335 respectively, into one or more columns based on the template. In various embodiments, the system is configured to format the Culled Data into one or more columns based on the template, which is at least partially in response to the user's placement of sources within the template in Step 315. In particular embodiments, the columns may be formatted differently depending on whether the website is being formatted, for example, for a mobile device as compared to a desktop version.

Continuing at Step 345, the system is configured to automatically update the Culled Data according to a pre-determined time schedule. In particular embodiments, the system is configured to update the Culled Data in real-time, or in various embodiments, the system may be configured to update the data on a preset schedule (e.g. hourly, daily, weekly, etc.). The amount of time that elapses between updates may vary based on the needs of the user. Some users may wish to provide real-time updates to their readers while others may wish to update once daily so that users can digest the Culled Data at one time, rather than needing to continually check for updates. In various embodiments, the system can be configured to present the Culled Data as an email, which may be sent according to the schedule for updating the Culled Data or independently via a scheduling application, as described in more detail below. In particular embodiments, the time that has elapsed since the last update of the Culled Data may be displayed to the user and the website's visitors.

Continuing to Step 350, the System is configured to provide the user with the generated computer instructions. In various embodiments, the System is configured to provide the computer instructions, at least partially generated in Step 320, to the user. In various embodiments, the system is configured to generate computer instructions that, in a particular embodiment, are designed to be embedded into a user's website. For example, the computer instructions, in various embodiments, are configured to be embedded into a WordPress site, a BlogSpot page, or a website of the user's own design.

In various embodiments, the system, when executing the Publication Module 300, may omit particular steps, perform particular steps in an order other than the order presented above, or perform additional steps not discussed directly above.

### Additional Embodiments

Email Campaign Service

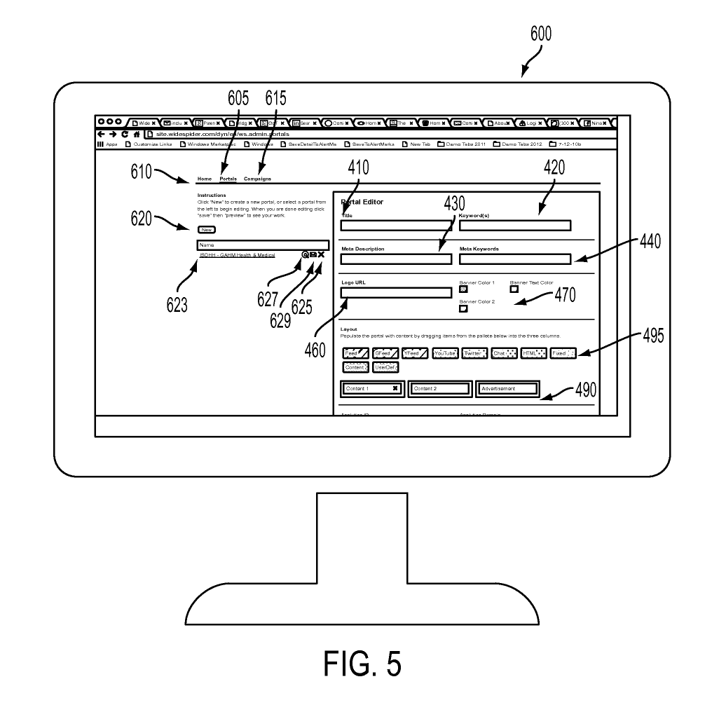

In various embodiments, the system may comprise a Publication Server coupled to one or more email servers 125 (FIG. 1) and associated e-mail databases. Referring to FIG. 5, in such embodiments, a user may setup an email campaign using the campaign portal page, to render the Culled Data for a given period of time (e.g. a day, week or number of days designated by the user, etc.) into a newsletter format. That is, rather than formatting the Culled Data to be displayed in a webpage, the information may instead be formatted for an email new letter. Thus, rather than requiring a user to frequently visit the website to determine whether or not there are new updates to the Culled Data, the user may instead opt-in to an email subscription service, in which Culled Data is rendered in an email newsletter format (e.g. HTML email, text only email, PDF attachment, etc.) and sent to the user via email.

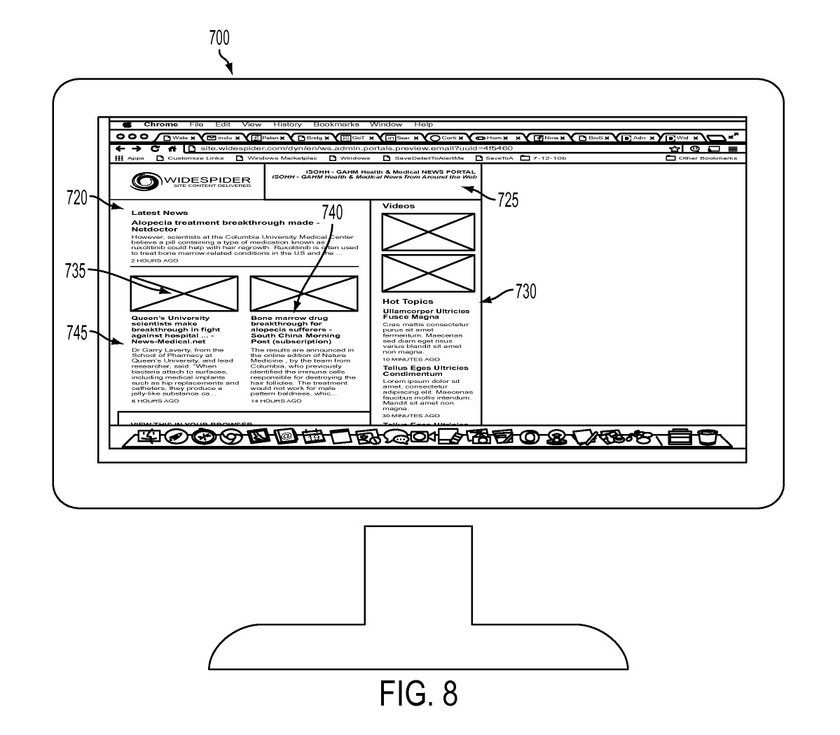

In various embodiments, the process of generating a customized content newsletter comprises a user entering at least one keyword in a keyword data field 420, selecting a first and second source from a plurality of available sources 495 to search for published content that is associated with the received keyword(s), and placing the first and second sources in a template 490. Referring to FIG. 8, the user may then search the selected first source for published content that is related to the received keyword(s) to generate a chronological listing of headlines 735 from the first source, and search the selected second source for published content that is related to the received keyword(s) to generate a chronological listing of headlines 740 from the second source. A summary of text 745 is generated for each headline in the first and second listings 735, 740, based on the published content. The first and second listings of headlines 735, 740 and the summary of text 745 associated with each respective headline is then formatted based on the template 490 to generate a newsletter 700. The newsletter 700, may, in turn be formatted as an email in HTML and scheduled to be delivered at a predetermined time each day.

The user may additionally add recipients to receive the selected email newsletter, further customize the appearance and formatting of the newsletter, or render the newsletter into a static or dynamic page with hyperlinks and short summaries generated from the published content associated with each hyperlink.

In various embodiments, the one or more email databases are configured to allow a potential recipient to opt-in to a compiled list of Culled Data, delivered regularly at an interval of the user's choosing. The recipient's email address may be stored in the email database, along with the user's list of keyword and media platform searches. Thus, when the user updates the list of keywords or media platforms across which the requested keywords are searched, this information may be automatically updated in the email database server. By updating the requested key words and media platforms in the email database, the system is designed to automatically deliver the next email newsletter with the new keyword search results seamlessly. In addition to storing the keywords and e-mail addresses, the formatting for the newsletter and the generated computer instructions may also be stored in the e-mail database so that all information is available to re-render the newsletter.

In the aforementioned particular embodiments, the formatting of the Culled Data may be variable based on the user's selected preferences. The variable features of the newsletter may include the font size and style, encoding as discussed above, layout, addition of headers/footers, etc. The newsletter may additionally be a re-rendered and formatted version of the webpage as it appears when the newsletter is formatted. Thus, the customized content webpage may include a feature wherein a user may subscribe to the newsletter directly from the webpage.

In various embodiments, the newsletter may be further formatted to allow for a multi-party publication campaign. Such embodiments may allow sponsors to draft original content to be placed in the generated newsletter alongside the Culled Data, the newsletter to also be formatted to allow multiple sponsors to place original content in the same newsletter, and the newsletter to include advertising content in addition to the reformatted Culled Data and original sponsored content. Sponsored content may be formatted for the newsletter as sponsored content or may be seamlessly integrated into the generated newsletter, such that it is indistinguishable from the Culled Data.

Subscriber Portal

In various embodiments, the system is further configured to allow for centralized user management of the newsletter subscription services through a subscriber portal. In particular embodiments, the subscriber portal allows for a newsletter recipient to view and manage all newsletter subscriptions of Culled Data. Such management may include altering the delivery schedule of the newsletter, how the newsletter is encoded (e.g. HTML, plaintext, etc.), options to unsubscribe from a newsletter or e-mail campaign, or subscribe to a suggested, related Culled Data webpage. In other embodiments, the subscriber portal may additionally provide the capability to view and manage all newsletter subscriptions and e-mail campaigns that the user receives.

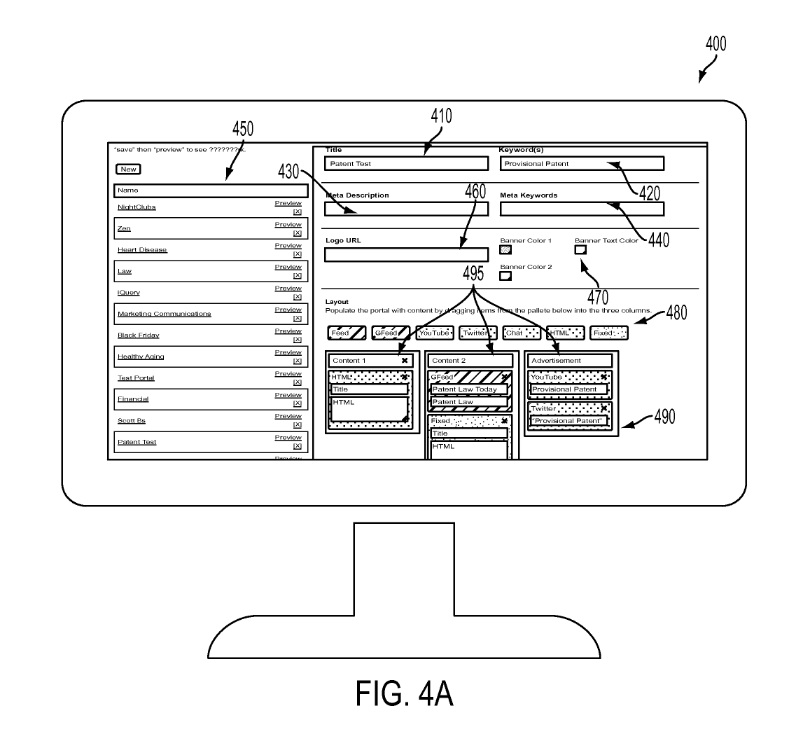

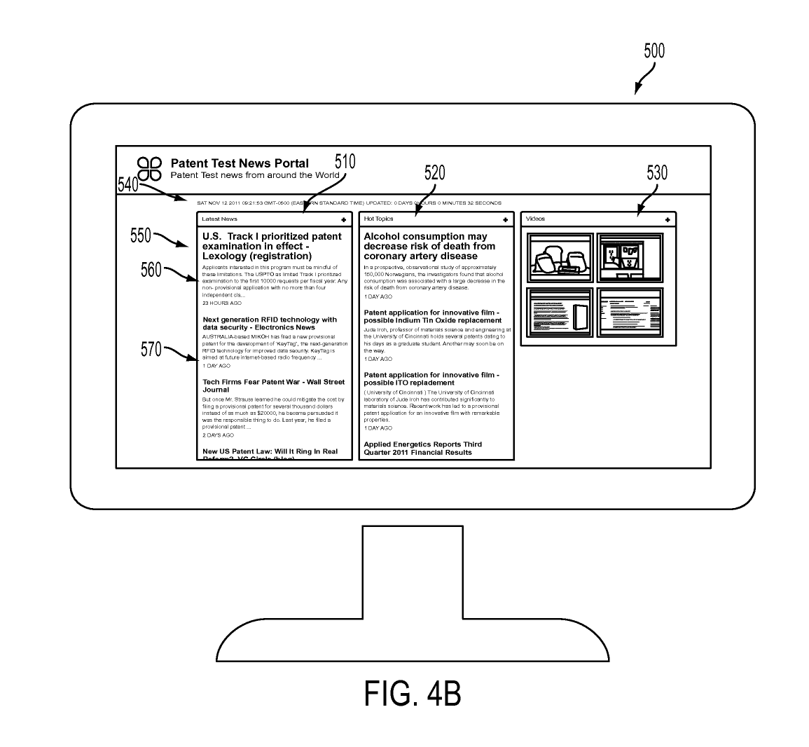

In other embodiments, the subscriber portal additionally provides a centralized portal through which a user can manage all Culled Data webpages that the user creates, as shown in FIG. 4A. Such management may include the addition or deletion of various webpages of Culled Data, adjustments to the layout of the Culled Data that is presented in the webpage (e.g. Culled Data, user-generated content, sponsored content, etc.), style formatting, addition or deletion of keywords, addition or deletion of sources for published content, and the modification of the predetermined templates.

### User Experience

FIGS. 4A-4B depict exemplary screen displays that a user may experience when using the system. FIG. 4A depicts a user interface 400 that illustrates a number of data fields for the user to input information associated with the customized publication that are utilized in the aforementioned search process. As may be understood from this figure, the user interface 400, includes: a Webpage Title data field 410, a Keywords data field 420 for the keyword(s) to be utilized by search engines, a Meta Description data field 430, a Meta Keywords data field 440, a Logo URL data field 460, and a Banner Color options area 470 that may be utilized by the user to set certain design elements and to affect the page listing on search engines.

As may be further understood from this figure, the user may designate which media sources from a listing 480 of media sources and provide the keywords in the keywords data field 420 that the system will search for across the selected media sources. Additionally, the system is configured to allow the user to drag and drop the selected media source(s) within a predetermined template 490 in one or more designated columns 495, that the system will utilize to organize the Culled Data. When a user selects a source and drags and drops the source into the predetermined template 490, the source is automatically populated with the keyword(s). The user may choose to leave the keyword(s) in the selected source or the user may change the keyword(s) by highlighting the prepopulated keyword and changing it using a data input device (e.g., a keyboard, touch screen, etc.). Along the left portion of the screen, a list of saved searches 450 enables the user to easily modify an existing page/search without the need to edit the computer instructions in order to add further keywords or media sources. This listing of existing pages/searches also allows the user to edit the search, delete an existing search, etc. The saved search display 450 further enables the user to preview the web page as it would appear to a user.

FIG. 4B depicts an exemplary screen display 500 of the custom published webpage as it would appear to a user. As may be understood from this figure, the screen display 500, organizes the Culled Data into 3 columns, 510, 520, 530. Columns 510 and 520 provide hyperlinks 550, summaries of text 560 based on the source, and is organized chronologically as indicated by the time stamp 570 underneath each source. As may be further understood from the figure, the last time the page was updated to reflect new Culled Data is indicated by a time stamp 540. The area 530 provides hyperlinks to a selected video media source, and thus a text summary is not included. Thus, in the particular example, the user selected a YouTube® search and placed the YouTube® source designator in the third column of the predetermined template 490.

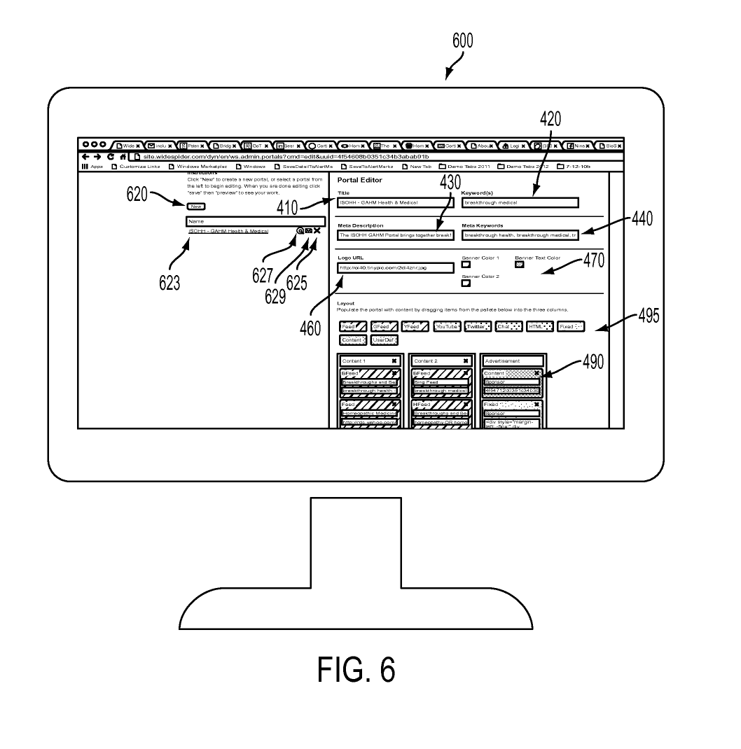

FIG. 5 depicts an exemplary screen display 600, of the Portal Editor webpage as it would appear to a user. As may be understood from this figure, the screen display 600 contains a Title data field 410, a keyword data field 420, Meta Description data field 430, Meta keywords data field 440, logo url 460, banner configuration options 470, source type 470, and culled data columns 490 to allow for the creation and configuration of a Culled Data pages. Additionally, new pages may be created via the new radio button 620 or existing Culled Data pages may be re-rendered as a Webpage by clicking the Earth icon 627, a newsletter by clicking the envelope icon 629, or deleted by clicking the red X icon 625. When the user clicks on a hyperlink 623 for an existing Culled Data webpage, the underlying data entries associated with the existing Culled Data webpage is populated in the Portal Editor, as shown in FIG. 6.

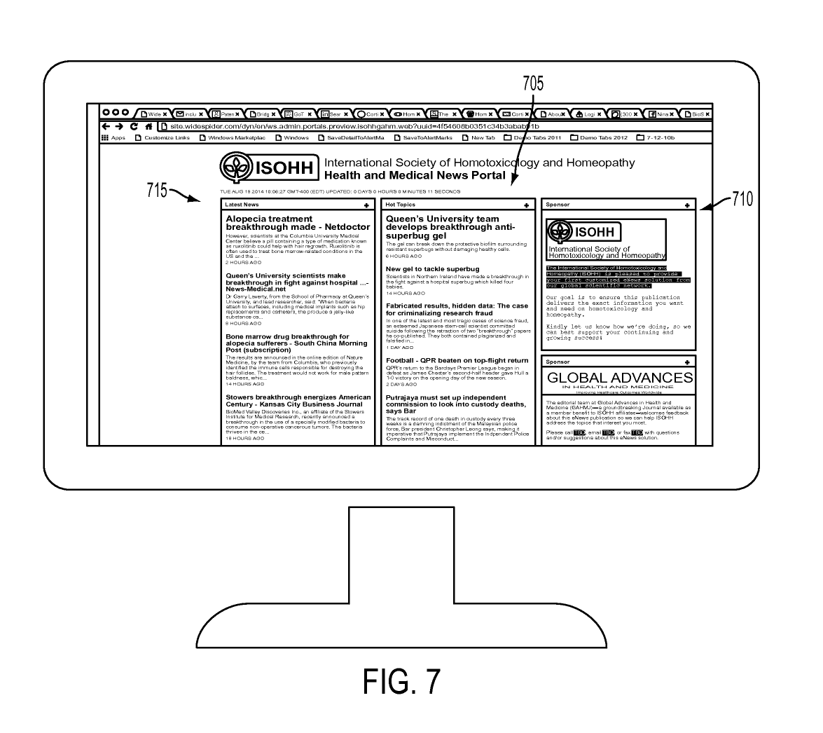

FIGS. 7, 8 depict exemplary screen displays of the rendered Culled Data pages of associated with the existing hyperlink 623 in FIG. 6. As may be further understood from these Figures, FIG. 7 depicts the Culled Data page as it would appear when rendered in webpage form when the user clicks the Earth icon 627 in FIG. 6. Moreover, FIG. 8 depicts the Culled Data page as it would appear when rendered in newsletter format when the user clicks the envelope icon 629 in FIG. 6.

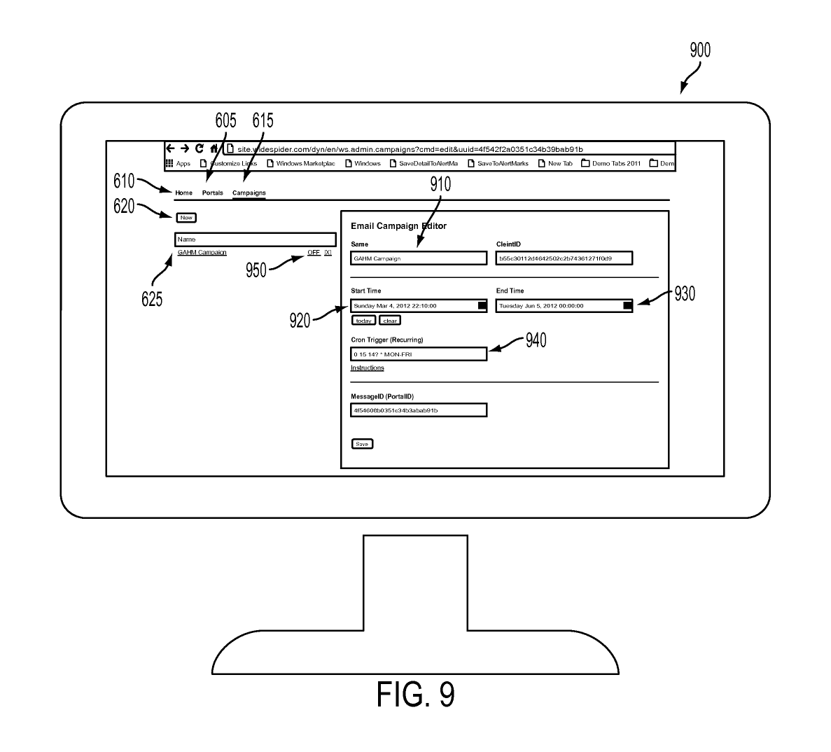

FIG. 9 depicts an exemplary screen display 900, of an Email Campaign Editor 615 as it would appear to a user. As may be further understood from this figure, the screen display 800, allows the user to configure the Name data field 910 to include a name of the e-mail campaign, a start time data field 920 that indicates when the e-mail newsletter campaign should begin, an end time data field 930 that indicates when the e-mail campaign should end, and a chronological trigger data field 940. The chronological trigger 940 is a user-defined time and frequency within the user-defined start time 920 and end time 930 when the email newsletter will be sent to subscribers. A toggle link 950 allows the user to turn an e-mail campaign off and on.

### Conclusion

Many modifications and other embodiments of the invention will come to mind to one skilled in the art to which this invention pertains, having the benefit of the teaching presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

1. A computer system for allowing a first and at least one sponsor for the user to publish customized content comprising:
a. at least one processor; and
b. memory operatively coupled to the at least one processor; wherein the at least one processor is configured to:
i. receive a first keyword from a user;
ii. allow the user to select a first at least one source of published content to search based on the received first keyword;
iii. allow the user to place the first at least one source in a predetermined template;
iv. allow the user to select a predefined location in the predetermined template that is configured to receive input from at least one sponsor;
v. receive content from the at least one sponsor;
vi. generate computer instructions that are configured to generate a webpage, wherein the generated computer instructions are configured to cause at least one processor to:
search the selected first at least one source for a first set of published content that is related to the received first keyword,
generate a first listing of hyperlinks for the first set of published content, wherein the first listing of hyperlinks is organized by a date and time the first set of published content was published,
generate a respective summary of text for each hyperlink in the first listing of hyperlinks, wherein the text is related to the respective published content associated with the hyperlink,
format the first listing of hyperlinks and the respective summary of text associated with each hyperlink into one or more columns based on the template,
format the content received from the at least one sponsor the predefined location in the predetermined template selected by the user; and
automatically update the first listing of hyperlinks and the respective summary associated with each hyperlink according to a predetermined time schedule; and
vii. provide access to the generated computer instructions to the user.

2. (canceled)

3. The system of claim 1, wherein the generated computer instructions are configured to be embedded in a website by the user so as to provide a webpage of customized published content as part of the website.

4. The system of claim 1, wherein the at least one processor is further configured to:
a. allow the user to highlight at least one word on a webpage;
b. open a menu having at least one link; and
c. allow the user to select the link thereby causing the at least one processor to receive the highlighted at least one word as the first keywords.

5. The system of claim 1, the first at least one source is selected from a group consisting of:
a. a Google® search;
b. a Yahoo® search;
c. a website address;
d. an RSS feed;
e. formatted text;
f. a YouTube® search; and
g. a Twitter® search.

6. The system of claim 1, wherein the processor is configured to:
a. allow the user to select a second source of published content to search based on a second received keyword;
b. allow the user to place the second source in the predetermined template; and
c. generate computer instructions that are configured to generate a webpage, wherein the generated computer instructions are configured to cause at least one processor to:
i. search the selected second source for published content that is related to the received second keyword,
ii. generate a second listing of hyperlinks for the published content, wherein the second listing of hyperlinks is based on search results from the second source,
iii. generate a summary of text for each hyperlink in the second listing of hyperlinks, wherein the text is related to the published content associated with the respective hyperlink,
iv. format the second listing of hyperlinks and the summary associated with each respective hyperlink into one or more columns based on the template, and
v. automatically update the second listing of hyperlinks and the summary associated with each respective hyperlink according to the predetermined time schedule.

7. The system of claim 6, wherein the predetermined time schedule is substantially continuous.

8. The system of claim 6, wherein the generated computer instructions are further configured to cause the at least one processor to organize the first listing of hyperlinks and the second listing of hyperlinks in order from the most recent published content to the oldest published content.

9. The computer-implemented method of claim 1, wherein the computer instructions comprise one or more computer instructions written in a computer language selected from a group consisting of:
a. HyperText Markup Language;
b. Javascript;
c. Cascading Style Sheets; and
d. Extensible Stylesheet Language.

10. A computer-implemented method of publishing custom content from a user and a sponsor of the user, comprising the steps of:
a. receiving, by a processor, a first keyword from a user;
b. building, by a processor, based on input from the user a layout for published content to be displayed, wherein the layout comprises predefined areas that are configured to receive additional content from one or more sponsors; and
c. receive additional content from the one or more sponsors, wherein
i. the additional content is assigned to a particular predefined area of the layout by the user prior to receiving the additional content; and
ii. the additional content is selected from a group consisting of:
(a) original content written by a sponsor; and
(b) original content written by one or more sponsors that are collaborating with the user to form a multi-party publication; and
d. generating, by a processor, computer instructions that are configured to generate a webpage, wherein the generated computer instructions are configured to cause a processor to:
i. search a network for published content that is related to the received at least one keyword,
ii. generate a listing of hyperlinks for the published content, wherein the listing of hyperlinks is organized by at least one of:
a ranking of the published content as ranked by the source of the published content,
a date and time the published content was published, and
the number of times the at least one keyword appears in the published content;
iii. format the listing of hyperlinks for the published content based on the layout,
iv. publish the additional content in the webpage in the particular predefined area assigned by the user, and
v. automatically update the listing of hyperlinks according to a predetermined schedule.

11. The computer-implemented method of claim 13, further comprising the step of generating a newsletter that comprises the formatted listing of hyperlinks for the published content, the respective summary that is associated with each one of the hyperlinks, and the additional content.

12. The computer-implemented method of claim 11, wherein the generated computer instructions allow one or more viewers of the webpage to subscribe to the generated newsletter.

13. The computer implemented method of claim 10, wherein the computer instructions are further configured to cause a processor to generate a respective summary that is associated with each one of the hyperlinks.

14. The computer-implemented method of claim 13, wherein the summary is based on text associated with the hyperlink.

15. The computer-implemented method of claim 14, wherein the summary is a predefined number of words or characters taken verbatim from the text associated with the hyperlink.

16. The computer-implemented method of claim 10, further comprising the step of providing, by a processor, the generated computer instructions to the user so that the user can embed the code into a preexisting website to create an information webpage that updates substantially continuously.

17. The computer-implemented method of claim 10, wherein the step of building a layout for the published content further comprises:
a. selecting at least one source of published content from a group consisting of:
i. a Google® search,
ii. a Yahoo® search,
iii. a website address,
iv. formatted text,
v. an RSS feed,
vi. a YouTube® search, and
vii. a Twitter® search;
b. applying the at least one keyword to the selected at least one source; and
c. placing the selected at least one source into one of a plurality of columns that correspond to at least one column in a displayed format.

18. The computer-implemented method of claim 10, wherein the step of receiving at least one keyword further comprises generating, by a processor, a user interface that is configured to allow the user to perform at least one step selected from a group consisting of:
a. entering the at least one keyword;
b. building the layout for the generated listing of hyperlinks;
c. providing a listing of all generated computer instructions associated with the user; and
d. managing account information of the user.

19. The computer-implemented method of claim 18, wherein the user interface is configured to allow the user:
a. to view a listing of all generated computer instructions associated with the user's account; and
b. delete at least one of the listed generated computer instructions.

20. (canceled)

21. A computer-implemented method of publishing custom content comprising the steps of:
a. presenting, by a processor, a user interface that is configured to:
i. receive one or more keywords from a user,
ii. receive a selection of one or more sources of published content from the user, and
iii. allow placement of the selected one or more sources of published content in a template that defines the layout of the published content;
b. receiving, by a processor, at least one keyword from the user via the user interface;
c. receiving, by a processor, a selection by the user of a first source to search for published content that is associated with the received at least one keyword;
d. receiving, by a processor, a selection by the user of a second source to search for published content that is associated with the received at least one keyword;
e. receiving, by a processor, a placement by the user of the selected first source in the template;
f. receiving, by a processor, a placement by the user of the selected second source in the template;
g. receiving, by a processor, from the first user a selection of a particular area in the template, wherein the particular area is configured to receive content from a sponsor wherein the content from the sponsor is selected from a group consisting of:
i. original written content by the sponsor, and
ii. original written content by multiple sponsors,
h. receiving, by a processor, the content from the sponsor; and
i. generating, by a processor, software code that causes at least one processor to:
i. search the selected first source for published content that is related to the received at least one keyword,
ii. generate a first listing of hyperlinks for the published content from the first source, wherein the first listing of hyperlinks are organized by a date and time the published content was published at the first source,
iii. search the selected second source for published content that is related to the received at least one keyword,
iv. generate a second listing of hyperlinks for the published content from the second source, wherein the second listing of hyperlinks are organized by a date and time the published content was published at the second source,
v. generate a summary of text for each hyperlink in the first and second listings, wherein the text is based on the published content associated with the respective hyperlink,
vi. format the first listing of hyperlinks and the summary of text for each hyperlink based at least on part on the location of the selected first source in the template,
vii. format the second listing of hyperlinks and the summary of text for each respective hyperlink based at least on part on the location of the second source in the template,
viii. format the received content based in part on a location of the particular area in the template selected by the user;
ix. publish the webpage on a network; and
x. automatically update the first and second listings of hyperlinks according to a predetermined schedule.

22. The computer-implemented method of claim 21, wherein
a. the at least one keyword further comprises a first keyword and a second keyword;
b. the first keyword is used to search the first source; and
c. the second keyword is used to search the second source.

23. The computer-implemented method of claim 21, further comprising:
a. receiving, by a processor, a request from a subscrib er to subscribe to a newsletter that is based on the published webpage;
b. generating, by a processor, a newsletter at least partially based on the request; and
c. transmitting the newsletter to the subscriber.

24. The computer-implemented method of claim 23, wherein the newsletter is transmitted at least partially based on a predetermined schedule.
